(19) United States
(12) Patent Application Publication
(10) Pub. No.: US 2016/0196552 A1
(43) Pub. Date: Jul. 7, 2016

(54) METHOD AND APPARATUS FOR PROVIDING PAYMENT SERVICE USING TEMPORARILY COMBINED BARCODE OF RANDOM NUMBER

(71) Applicant: SK Planet Co., Ltd., Gyeonggi-do (KR)

(72) Inventor: Sebyung KWAK, Seoul (KR)

(73) Assignee: SK Planet Co., Ltd., Gyeonggi-do (KR)

(21) Appl. No.: 14/975,207

(22) Filed: Dec. 18, 2015

(30) Foreign Application Priority Data
Jan. 6, 2015 (KR) 10-2015-0001040

(51) Int. Cl. G06Q 20/38; G06Q 20/32; G06Q 20/20

(52) U.S. Cl. CPC G06Q 20/385; G06Q 20/204; G06Q 20/387; G06Q 20/3274

(57) ABSTRACT

The present invention relates to a payment service system using a temporarily combined barcode of a random number, and a payment service device and method in the system. A customer may input a password and request a combined barcode by utilizing a mobile terminal before making payment, a temporarily combined barcode of a random number may be issued, and a POS of a corresponding store may read information such as memberships in which the customer signs as a member in advance, coupons, and the like when the customer presents the combined barcode to a cashier, so that all memberships, coupons, points, and the like may be automatically applied and even payment may be performed, and therefore customers may combine and use several types of barcodes into only a single barcode without the need to possess the several types of barcodes

### CROSS-REFERENCE TO RELATED APPLICATION

This application claims priority to and the benefit of Korean Patent Application No. 10-2015-0001040 filed in the Korean Intellectual Property Office on Jan. 6, 2015, the entire contents of which are incorporated herein by reference.

### TECHNICAL FIELD

The present invention relates to a payment service method and apparatus using a temporarily combined barcode of a random number, and more particularly, to a payment service method and apparatus using a temporarily combined barcode of a random number, in which a customer may combine and use several types of barcodes such as membership points, coupons, and the like into only a single barcode without the need to possess the several types of barcodes, make even payment to omit an existing operation for independently performing discount and payment, and utilize the combined barcode having characteristics which are changed depending on a password input and over time to improve security.

### BACKGROUND

With the development of a mobile communication network and terminal specification, a mobile communication terminal has become essential belongings of modern people beyond a conventional simple communication device or information providing device, and has a tendency to evolve into a total entertainment device. In particular, the mobile communication terminal which can be referred to as the modern necessities has been reduced in its size and weight due to its steady progress, and is being reborn as a composite communication terminal having various functions.

Such a mobile communication terminal may provide a barcode recognition function, and the barcode which is attached to a product to recognize production information is read by a barcode scanner currently provided in a cash register or a POS (Point Of Sales) system of a large store and is usefully used when sales data is automatically organized. The code system of the barcode is expanded from one-dimensional array into two or more dimensional array, and information that can be contained in the code system has rapidly increased, so that the usage range is being expanded day by day.

Meanwhile, when purchasing a product in a specific store, a product barcode is read through a POS terminal within the store, a customer should browse a card for receiving a discount benefit one by one among cards which the customer possesses and present the browsed card to a cashier so that payment for the product is made.

In this manner, in recent years, when purchasing a product, the cashier tags the product barcode one by one, and then the customer should determine one by one which card has the biggest discount among the cards possessed by the customer in order to receive the discount benefit and present the determined card. In addition, when there are a large number of cards having discount benefit, individual cards should be separately provided.

Thus, there is an increased demand for developing a method for more rapidly and conveniently performing payment service when purchasing a product.

### PRIOR ART DOCUMENT

### Patent Document

Korean Patent No. 10-1106285B, published on Feb. 9, 2012 (Title: System for processing payment information using combined barcode and control method for mobile device)

### SUMMARY

The present invention is directed to providing a payment service system using a temporarily combined barcode of a random number, in which customers may combine and use several types of barcodes such as membership points, coupons, and the like into only a single barcode without the need to possess the several types of barcodes, and make even payment to omit an existing operation for independently performing discount and payment, and a payment service device and method in the system.

In addition, the present invention is directed to providing a payment service system using a temporarily combined barcode of a random number, in which the combined barcode having characteristics which are changed depending on a password input and over time may be utilized to improve security, and a payment service device and method in the system.

One aspect of the present invention provides a service device including: a service communication unit that transmits and receives data associated with a payment service by communicating with one or more terminals and payment devices; a service storage unit that stores payment information including payment means information including information about a payment method for each user and payment additional information including information for discount; and a service control unit that controls to generate a temporarily combined barcode of a random number using the stored payment information with respect to a user of the terminal requesting a combined barcode when receiving a combined barcode request signal from the terminal and transmit the temporarily combined barcode to the terminal through the service communication unit.

Here, when there is a request for information associated with the temporarily combined barcode from the payment device, the service device may provide payment information about a user corresponding to the corresponding temporarily combined barcode as related information, to the payment device.

Also, the temporarily combined barcode of the random number may include payment information provided by the user when the terminal requests the combined barcode service, and may be generated using a program for generating a random number.

Also, the payment additional information may include at least one of discount card information, point accumulation information for each card, and mileage accumulation information.

Also, the payment means information may include at least one of a credit card, a debit card, a gift card, and account transfer information.

Yet another aspect of the present invention provides a payment service method including: requesting, by a terminal, a combined barcode from a service device so as to receive a payment service using a temporarily combined barcode of a random number from a user, when receiving an input of user information including a password and payment information from the user; transmitting a combined barcode request signal to the service device when there is an input for a combined barcode request; temporarily storing, when receiving the temporarily combined barcode from the service device, the received temporarily combined barcode; determining whether a payment operation is performed using the temporarily combined barcode within a preset time; and deleting the stored temporarily combined barcode when the payment operation is not performed based on the determination result.

Further aspect of the present invention provides a payment service method including: storing and managing, by a service device, a password and payment information received for each user, when receiving the password and payment information for a combined barcode request from a terminal; generating a temporarily combined barcode of a random number using the payment information stored with respect to the user of the terminal requesting a combined barcode, when receiving a combined barcode request signal from the terminal; and transmitting the generated temporarily combined barcode to the terminal.

Also, the generating of the temporarily combined barcode of the random number may include the payment information provided by the user when the terminal requests the combined barcode service, and include generating the temporarily combined barcode of the random number using a program for generating a random number.

Further aspect of the present invention provides a computer-readable recording medium for recording a program that executes the payment service method.

According to an embodiment of the present invention, a customer may input a password and request a combined barcode by utilizing a mobile terminal before making payment, a temporarily combined barcode of a random number may be issued, and a POS of a corresponding store may read information such as memberships in which the customer signs as a member in advance, coupons, and the like when the customer presents the combined barcode to a cashier, so that all memberships, coupons, points, and the like may be automatically applied and even payment may be performed.

Therefore, customers may combine and use several types of barcodes such as membership points, coupons, and the like into only a single barcode without the need to possess the several types of barcodes, make even payment to omit an existing operation for independently performing discount and payment, and utilize the combined barcode having characteristics which are changed depending on a password input and over time to improve security.

### BRIEF DESCRIPTION OF DRAWINGS

FIG. 1 is a view showing the configuration of a payment service system using a temporarily combined barcode of a random number according to an embodiment of the present invention.

FIG. 2 is a block diagram showing the configuration of a terminal according to an embodiment of the present invention.

FIG. 3 is a block diagram showing the configuration of a service device according to an embodiment of the present invention.

FIG. 4 is a flowchart showing a signal flow between individual components for providing a payment service using a temporarily combined barcode of a random number in a payment service system according to an embodiment of the present invention.

FIG. 5 is a flowchart showing an operating method of a terminal for providing a payment service using a temporarily combined barcode of a random number according to an embodiment of the present invention.

FIG. 6 is a flowchart showing an operating method of a service device for providing a payment service using a temporarily combined barcode of a random number according to an embodiment of the present invention.

### DETAILED DESCRIPTION

Hereinafter, embodiments of the present invention will be described in detail with reference to the accompanying drawings. However, in the description and the accompanying drawings, well-known functions or constructions which may obscure the subject matter of the present invention will be omitted. In addition, the same components throughout the drawings are to be noted that as indicated by the same reference numerals.

It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

Hereinafter, as a representative example of a terminal according to an embodiment of the present invention, a mobile communication terminal that can be connected to a communication network and perform a payment service using a combined barcode will be described, but the terminal is not limited to the mobile communication terminal and may be applied to various terminals such as all information communication devices, multimedia terminals, wired terminals, fixed terminals, IP (Internet Protocol) terminals, and the like. In addition, when the terminal is a mobile terminal having various mobile communication specifications such as a cell phone, a PMP (Portable Multimedia Player), an MID (Mobile Internet Device), a smartphone, a desktop, a tablet PC, a laptop, a Netbook, an information communication device, and the like, the terminal may be advantageously utilized.

Hereinafter, a payment service system using a temporarily combined barcode of a random number according to an embodiment of the present invention will be described.

FIG. 1 is a view showing the configuration of a payment service system using a temporally combined barcode of a random number according to an embodiment of the present invention.

Referring to FIG. 1, a payment service system using a temporally combined barcode of a random number according to an embodiment of the present invention includes a terminal 10, a service device 20, a POS (Point Of Sales) device 30, a payment device 40, and a communication network 50.

A processor mounted in the terminal 10 or the service device 20 according to the present invention may process program instructions for executing a method according to the present invention. In an implementation example, this processor may be a single-threaded processor, and in another implementation example, the present processor may be a multi-threaded processor. Furthermore, the present processor is capable of processing instructions stored in a memory or a storage device.

The communication network 50 performs a series of data transmission and reception operations for data transmission and information exchange between the terminal 10 and the service device 20. In particular, as the communication network 50, various types of communication networks may be used, and for example, a wireless communication method such as WLAN (Wireless LAN), Wi-Fi, Wibro, Wimax, HSDPA (High Speed Downlink Packet Access), and the like, or a wired communication method such as Ethernet, xDSL (ADSL, VDSL), HFC (Hybrid Fiber Coax), FTTC (Fiber to The Curb), FTTH (Fiber To The Home), and the like may be used. Meanwhile, the communication network 50 is not limited to the above-mentioned communication methods, and may include all types of other communication methods which are widely known or will be developed in the future in addition to the above-mentioned communication methods.

The terminal 10 is connected to the service device 20, the POS device 30, and the payment device 40 through the communication network 50, and transmits and receives all data associated with providing of a combined barcode. In particular, the terminal 10 according to the present invention requests a combined barcode service from the service device 20 according to a user's operation. User information required when requesting the combined barcode service is payment additional information including at least one of a password for security, discount card information, point accumulation information for each card, and mileage accumulation information when using a payment service using a temporarily combined barcode, and payment means information including at least one of a credit card, a debit card, a gift card, and account transfer information. When requesting the combined barcode service, the terminal 10 receives an input of the user information from the user, and transmits the user information to the service device 20. In addition, when there is an input for a combined barcode request from the user, the terminal 10 transmits a combined barcode request signal to the service device 20. Next, when receiving the temporarily combined barcode from the service device 20, the terminal 10 temporarily stores the received combined barcode, and when a payment operation is not performed using the received temporarily combined barcode within a preset time, the terminal 10 deletes the received temporarily combined barcode. For example, when payment is not performed within one minute after receiving the temporarily combined barcode, the temporarily combined barcode may be automatically deleted.

The service device 20 is connected to the terminal 10, the POS device 30, and the payment device 40 through the communication network 50, and transmits and receives all data associated with providing of a combined barcode for a payment service.

In particular, when receiving the combined barcode request signal from the terminal 10, the service device 20 according to the present invention generates a temporarily combined barcode of a random number using stored payment information with respect to a user of the terminal 10 requesting the combined barcode. In this instance, the temporarily combined barcode of the random number includes payment information provided by the user when the terminal 10 requests the combined barcode service, and may be generated using a program for generating a random number. In addition, the service device 20 transmits the temporarily combined barcode generated in this manner to the terminal 10.

Next, when there is a request for information associated with the temporarily combined barcode from the payment device 40, the service device 20 provides user information about a user corresponding to the corresponding temporarily combined barcode as related information to the payment device 40. That is, the service device 20 may be linked with the payment device 40 when performing a payment service using the combined barcode according to the request of the terminal 10.

The POS device 30 may be installed within an affiliated store, and recognize the combined barcode in response to the request of the terminal 10 and provide the payment service.

The payment device 40 is a server operated by payment institutions such as financial institutions performing authentication and payment approval business associated with mobile payment, credit card companies, or mobile carriers, and performs authentication and payment approval business associated with the temporarily combined barcode of the random number used by the terminal 10.

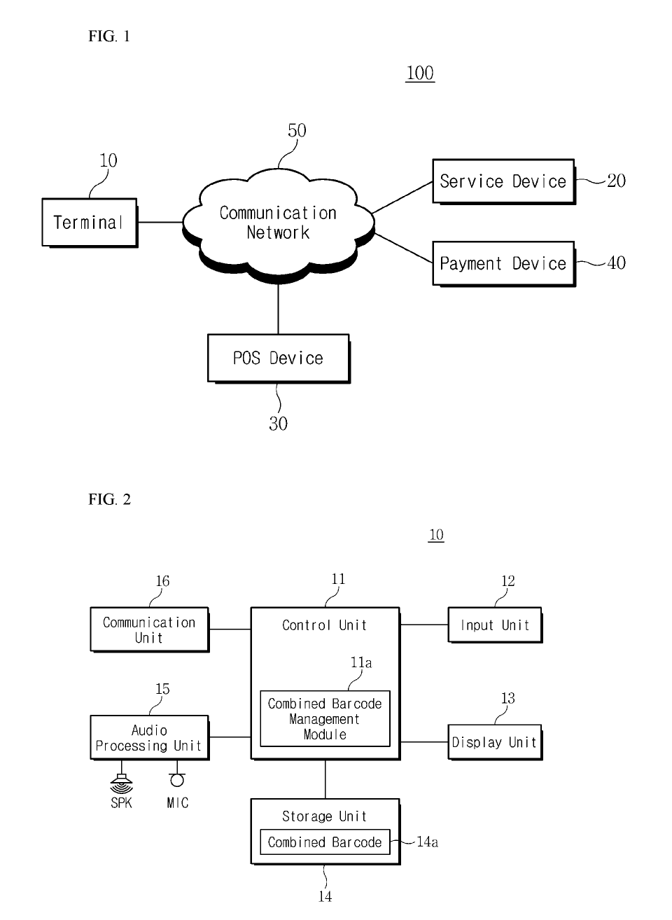

The internal configuration of the terminal for providing the payment service in the above-described payment service system using the temporarily combined barcode of the random number according to an embodiment of the present invention will be specifically described with reference to FIG. 2.

FIG. 2 is a block diagram showing the configuration of a terminal according to an embodiment of the present invention.

Referring to FIG. 2, the terminal 10 according to the present invention includes a control unit 11, an input unit 12, a display unit 13, a storage unit 14, an audio processing unit 15, and a communication unit 16. Here, the control unit 11 includes a combined barcode management module 11a.

The input unit 12 receives an input of a variety of information such as numeral or character information, and the like, and transmits signals input in association with setting of various functions and function control of the terminal 10, to the control unit 11. In addition, the input unit 12 may include at least one of a keypad and a touchpad which generate input signals according to a user's touch or manipulation. In this instance, the input unit 12 may be configured in the form of a single touch panel (or a touch screen) together with the display unit 13, and simultaneously perform input and display functions. In addition, as the input unit 12, all types of input means which will be developed in the future, in addition to an input device such as a keyboard, a keypad, a mouse, a joystick, or the like, may be used. In particular, the input unit 12 according to the present invention detects all input signals associated with providing of the payment service using the temporarily combined barcode of the random number, and transmits the detected signals to the control unit 11.

The display unit 13 displays information about a series of operating states and results generated while the function of the terminal 10 is performed. In addition, the display unit 13 may display menus of the terminal 10, user data input by a user, and the like. Here, the display unit 13 may be provided in the form of an LCD (Liquid Crystal Display), a TFT-LCD (Thin Film Transistor LCD), an LED (Light Emitting Diode), an OLED (Organic LED), an AMOLED (Active Matrix OLED), a Retina display, a flexible display, a three-dimensional (3D) display, or the like. In this instance, when being configured in the form of a touch screen, the display unit 13 may perform some or all of the functions of the input unit 12. In particular, the display unit 13 according to the present invention outputs all information associated with providing of the payment service using the temporarily combined barcode of the random number.

The storage unit 14 is a device for storing data, includes a main storage device and an auxiliary storage device, and stores application programs required for function operations of the terminal 10. Such a storage unit 14 may roughly include a program region and a data region. Here, when activating individual functions in response to a user's requests, the terminal 10 may execute the corresponding application programs under the control of the control unit 11 and provide the individual functions. In particular, the storage unit 14 according to the present invention stores an OS (Operating System) for booting the terminal 10, a program for performing the payment service using the temporarily combined barcode of the random number, and the like. In particular, the storage unit 14 stores the temporarily combined barcode of the random number received from the service device 20.

The audio processing unit 15 performs a function of transmitting audio signals input from a speaker (SPK) or a microphone (MIC) for reproducing and outputting the audio signals, to the control unit 11. The audio processing unit 15 may convert an analog audio signal input through the microphone into a digital audio signal, and transmit the converted digital audio signal to the control unit 11. In addition, the audio processing unit 15 may convert a digital audio signal output from the control unit 11 into an analog audio signal, and output the converted analog audio signal through the speaker. In particular, the audio processing unit 15 according to the present invention outputs an effect sound or an execution sound associated with providing of the payment service using the temporarily combined barcode of the random number.

The communication unit 16 performs a function for transmitting and receiving data to and from the service device 20, the POS device 30, and the payment device 40 through the communication network 50. Here, the communication unit 16 includes an RF transmission means that increases, converts, and amplifies the frequency of a transmitted signal, an RF reception means that performs low noise amplification of a received signal, and decreases and converts the frequency of the received signal, and the like. Such a communication unit 16 may include at least one of a wireless communication module (not shown) and a wired communication module (not shown). Here, the wireless communication module is a component for transmitting and receiving data according to a wireless communication method, and when using wireless communication, the terminal 10 may transmit and receive data to and from the service device 20 using any one of a wireless network communication module, a wireless LAN communication module, and a WPAN (Wireless Personal Area Network) communication module. In addition, the wired communication module is a component for transmitting and receiving data in a wired manner. The wired communication module may access the communication network 50 in a wired manner, and transmit and receive data to and from the service device 20. In particular, the communication unit 16 according to the present invention transmits and receives data associated with the payment service using the temporarily combined barcode of the random number by communicating with the service device 20 and the POS device 30.

The control unit 11 may be a process device that drives an OS and individual components. In particular, the control unit 11 according to an embodiment of the present invention requests a combined barcode service from the service device 20 according to a user's operation. User information required when requesting the combined barcode service is payment additional information including at least one of a password for security, discount card information, point accumulation information for each card, and mileage accumulation information when using the payment service using the temporarily combined barcode, and payment means information including at least one of a credit card, a debit card, a gift card, and account transfer information. When requesting the combined barcode service, the control unit 11 receives an input of the user information from the user, and transmits the user information to the service device 20. In addition, when there is an input for a combined barcode request from the user, the control unit 11 transmits a combined barcode request signal to the service device 20. Next, when receiving the temporarily combined barcode from the service device 20, the control unit 11 temporarily stores the received combined barcode, and when a payment operation is not performed using the received temporarily combined barcode within a preset time, the control unit 11 deletes the received temporarily combined barcode. For example, when payment is not performed within one minute after receiving the temporarily combined barcode, the temporarily combined barcode may be automatically deleted.

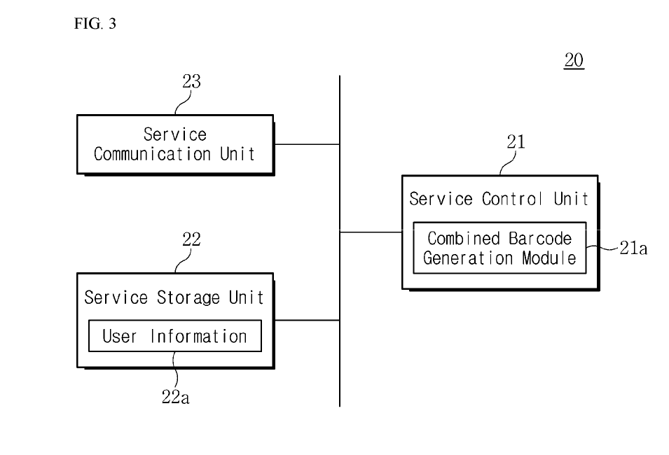

Next, the internal configuration of the service device for providing the payment service in the above-described payment service system using the temporarily combined barcode of the random number according to an embodiment of the present invention will be specifically described with reference to FIG. 3.

FIG. 3 is a block diagram showing the configuration of a service device according to an embodiment of the present invention.

Referring to FIG. 3, the service device 20 according to the present invention includes a service control unit 21, a service storage unit 22, and a service communication unit 23. Here, the service control unit 21 includes a combined barcode generation module 21a.

The service communication unit 23 performs a function of transmitting and receiving all data associated with providing of the payment service using a temporarily combined barcode of a random number, to and from the terminal 10, the POS device 30, and the payment device 40 through the communication network 50.

The service storage unit 22 stores all programs according to the function execution of the service device 20. In particular, the service storage unit 22 according to the present invention stores a program for generating the temporarily combined barcode of the random number for each user. In addition, the service storage unit 22 stores user information for each user. In this instance, the user information stores payment additional information including a password, discount card information, point accumulation information for each card, and mileage accumulation information which are input upon registering the payment service using the temporarily combined barcode, and payment means information corresponding to a credit card, a debit card, a gift card, and account transfer information.

The service control unit 21 may be a process device that drives an OS and individual components. In particular, when receiving a combined barcode request signal from the terminal 10, the service control unit 21 according to an embodiment of the present invention generates the temporarily combined barcode of the random number using stored payment information with respect to a user of the terminal 10 requesting the combined barcode. In this instance, the temporarily combined barcode of the random number includes payment information provided by the user when the terminal 10 requests the combined barcode service, and may be generated using a program for generating a random number. In addition, the service control unit 21 transmits the temporarily combined barcode generated in this manner to the terminal 10.

Next, when there is a request for information associated with the temporarily combined barcode from the payment device 40, the service control unit 21 provides user information about a user corresponding to the corresponding temporarily combined barcode as related information to the payment device 40. That is, the service control unit 21 may be linked with the payment device 40 when performing a payment service using the combined barcode according to the request of the terminal 10.

In order to more effectively perform the function of the service device 20, the service control unit 21 according to the present invention includes the combined barcode generation module 21a. The combined barcode generation module 21a generates the temporarily combined barcode of the random number using the stored payment information with respect to the user of the terminal 10 requesting the combined barcode. In this instance, the temporarily combined barcode of the random number may include payment information provided by the user when the terminal 10 requests the combined barcode service, and may be generated using a program for generating a random number.

Meanwhile, a memory mounted in the terminal 10 or the service device 20 may store information within the corresponding device. In a case of one implementation example, the memory is a computer-readable medium. In one implementation example, the memory may be a volatile memory unit, and in another implementation example, the memory may be a non-volatile memory unit. In the case of one implementation example, a storage device is a computer-readable medium. In various different implementation examples, the storage device may include, for example, a hard disk device, an optical disc device, and any other large capacity storage devices.

Although an exemplary device configuration is described in the present specification and drawings, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program storage medium for execution by, or to control the operation of, a processing system. The computer-readable medium can be a machine-readable storage device, a machine-readable storage substrate, a memory device, a composition of matter affecting a machine-readable propagated signal, or a combination of one or more of them.

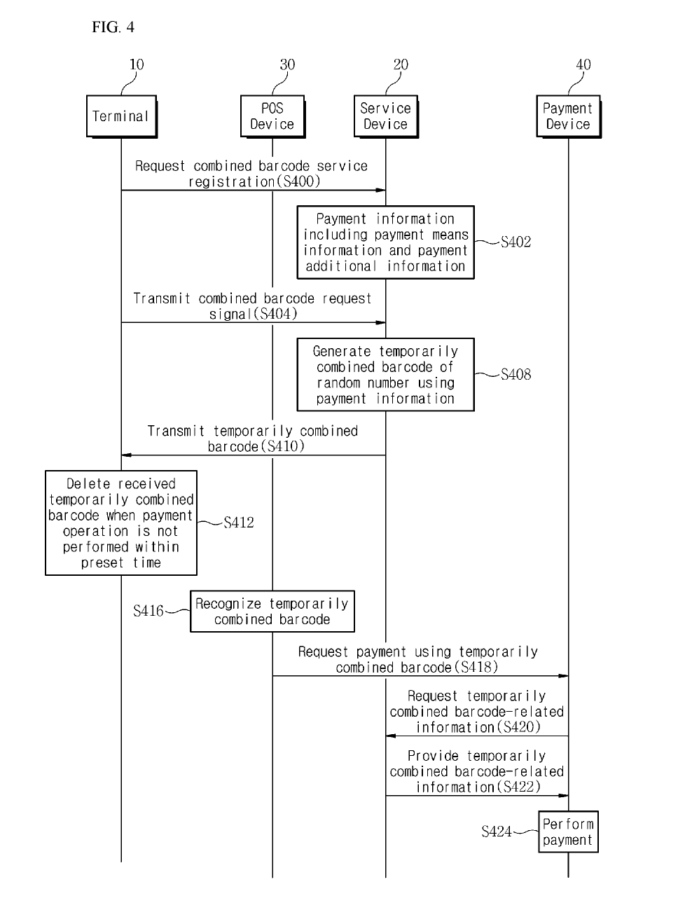

FIG. 4 is a flowchart showing a signal flow between individual components for providing a payment service using a temporarily combined barcode of a random number in a payment service system according to an embodiment of the present invention.

Referring to FIG. 4, in operation S400, the terminal 10 requests a combined barcode service from the service device 20 according to a user's operation. User information required when requesting the combined barcode service is payment additional information including at least one of a password for security, discount card information, point accumulation information for each card, and mileage accumulation information when using a payment service using a temporarily combined barcode, and payment means information including at least one of a credit card, a debit card, a gift card, and account transfer information. When requesting the combined barcode service, the terminal 10 receives an input of the user information from the user, and transmits the user information to the service device 20.

Next, in operation S402, the service device 20 registers payment information including payment means information and payment additional information for each user.

Next, in operation S404, when there is an input for a combined barcode request from the user, the terminal 10 transmits a combined barcode request signal to the service device 20.

The service device 20 generates a temporarily combined barcode of a random number using stored payment information with respect to a user of the terminal 10 requesting the combined barcode. In this instance, the temporarily combined barcode of the random number includes payment information provided by the user when the terminal 10 requests the combined barcode service, and may be generated using a program for generating a random number.

The service device 20 transmits the temporarily combined barcode generated in this manner to the terminal 10, and the terminal 10 having received the temporarily combined barcode temporarily stores the received temporarily combined barcode.

Next, when a payment operation is not performed using the received temporarily combined barcode within a preset time, the terminal 10 deletes the received temporarily combined barcode. For example, when payment is not performed within one minute after receiving the temporarily combined barcode, the temporarily combined barcode may be automatically deleted.

Next, when the user presents the temporarily combined barcode transmitted to his or her terminal 10 to a cashier, the cashier performs payment through the POS device 30.

That is, in operations 5416 and 5418, when the POS device 30 recognizes the temporarily combined barcode, the terminal 10 requests payment from the payment device 40 using the recognized temporarily combined barcode.

Next, in operations 5422 and 5424, the payment device 40 requests temporarily combined barcode-related information from the service device 20, and performs, when receiving the related information, payment using the received related information.

That is, the POS device of the corresponding store may read information such as memberships in which a customer signs as a member in advance, coupons, and the like, so that all memberships, coupons, points, and the like may be automatically applied and even payment may be performed.

As described above, a customer may input a password and request a combined barcode by utilizing a mobile terminal before making payment, a temporarily combined barcode of a random number may be issued, and the POS of the corresponding store may read information such as memberships in which the customer signs as a member in advance, coupons, and the like when the customer presents the combined barcode to a cashier, so that all memberships, coupons, points, and the like may be automatically applied and even payment may be performed.

Therefore, customers may combine and use several types of barcodes such as membership points, coupons, and the like into only a single barcode without the need to possess the several types of barcodes, make even payment to omit an existing operation for independently performing discount and payment, and utilize the combined barcode having characteristics which are changed depending on a password input and over time to improve security.

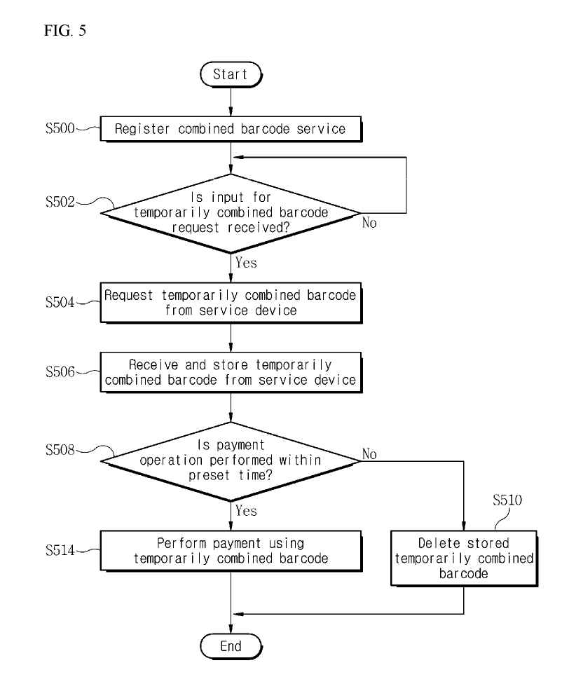

FIG. 5 is a flowchart showing an operating method of a terminal for providing a payment service using a temporarily combined barcode of a random number according to an embodiment of the present invention.

Referring to FIG. 5, in operation S500, the terminal 10 requests a combined barcode service from the service device 20 according to a user's operation. User information required when requesting the combined barcode service is payment additional information including at least one of a password for security, discount card information, point accumulation information for each card, and mileage accumulation information when using a payment service using a temporarily combined barcode, and payment means information including at least one of a credit card, a debit card, a gift card, and account transfer information. When requesting the combined barcode service, the terminal 10 receives an input of the user information from the user, and transmits the user information to the service device 20.

In operations S502 and S504, when there is an input for a combined barcode request from the user, the terminal 10 transmits a combined barcode request signal to the service device 20.

In operation S506, when receiving the temporarily combined barcode from the service device 20, the terminal 10 temporarily stores the received combined barcode.

Next, in operations S508 and S510, when a payment operation is not performed using the received temporarily combined barcode within a preset time, the terminal 10 deletes the received temporarily combined barcode. For example, when payment is not performed within one minute after receiving the temporarily combined barcode, the temporarily combined barcode may be automatically deleted.

Next, when the user presents the temporarily combined barcode transmitted to his or her terminal 10 to a cashier, the cashier performs payment through the POS device 30.

That is, the POS device of the corresponding store may read information such as memberships in which a customer signs as a member in advance, coupons, and the like, so that all memberships, coupons, points, and the like may be automatically applied and even payment may be performed.

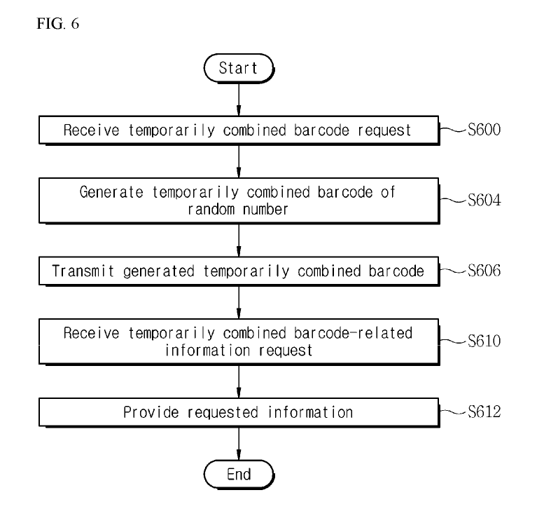

FIG. 6 is a flowchart showing an operating method of a service device for providing a payment service using a temporarily combined barcode of a random number according to an embodiment of the present invention. In FIG. 6, it is assumed that the service device 30(20) registers and manages payment information including payment means information and payment additional information for each user by performing operation S500 of FIG. 5.

When receiving the combined barcode request signal from the terminal 10, the service device 20 generates a temporarily combined barcode of a random number using stored payment information with respect to a user of the terminal 10 requesting the combined barcode service. In this instance, in operations S600 to S604, the temporarily combined barcode of the random number may include the payment information provided by the user when the terminal 10 requests the combined barcode service, and may be generated using a program for generating a random number.

In operation S606, the service device 20 transmits the temporarily combined barcode generated in this manner to the terminal 10.

Next, in operation S612, when there is a request for information associated with the temporarily combined barcode from the payment device 40, the service device 20 provides user information about a user corresponding to the corresponding temporarily combined barcode as related information to the payment device 40.

Implementations of the various techniques described herein may be implemented in digital electronic circuitry, or in computer hardware, firmware, software, or in a combination of them. Implementations may be implemented as a computer program product, i.e., a computer program tangibly embodied in an information carrier, e.g., in a machine-readable storage device (computer-readable medium) or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. The computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., magnetic media such as a hard disk, floppy disk, and magnetic tape; optical media such as a CD-ROM (Compact Disc Read-Only Memory) and DVD (Digital Video Disc); magneto-optical media such as a floptical disk; a ROM (Read-Only Memory), RAM (Random Access Memory), flash memory device, EPROM (Erasable Programmable ROM), EEPROM (Electrically Erasable Programmable ROM), and the like. The processor and the memory can be supplemented by, or incorporated in special purpose logic circuitry.

While this specification contains many specific implementation details, these should not be construed as limitations on the scope of any invention or of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excluded from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Meanwhile, the embodiments of the invention disclosed in the specification and drawings are presented merely as a specific example for clarity and are not intended to limit the scope of the invention. It will be apparent to those of ordinary skill in the art that other modification based on the technical spirit of the present invention can be carried out in addition to the embodiments disclosed herein.

According to the present invention, a customer may input a password and request a combined barcode by utilizing a mobile terminal before making payment, a temporarily combined barcode of a random number may be issued, and a POS of a corresponding store may read information such as memberships in which the customer signs as a member in advance, coupons, and the like when the customer presents the combined barcode to a cashier, so that all memberships, coupons, points, and the like may be automatically applied and even payment may be performed.

Therefore, customers may combine and use several types of barcodes such as membership points, coupons, and the like into only a single barcode without the need to possess the several types of barcodes, make even payment to omit an existing operation for independently performing discount and payment, and utilize the combined barcode having characteristics which are changed depending on a password input and over time to improve security.

In addition, the degree to which the present invention can obviously be carried out in reality, as well as a commercial or business potential, is likely to be sufficient for industrial applicability.

In this specification, exemplary embodiments of the present invention have been classified into the first, second and third exemplary embodiments and described for conciseness. However, respective steps or functions of an exemplary embodiment may be combined with those of another exemplary embodiment to implement still another exemplary embodiment of the present invention.

What is claimed is:

1. A service device comprising:
a service communication unit that transmits and receives data associated with a payment service by communicating with one or more terminals and payment devices;
a service storage unit that stores payment information including payment means information including information about a payment method for each user and payment additional information including information for discount; and
a service control unit that controls to generate a temporarily combined barcode of a random number using the stored payment information with respect to a user of the terminal requesting a combined barcode when receiving a combined barcode request signal from the terminal and transmit the temporarily combined barcode to the terminal through the service communication unit.

2. The service device according to claim 1, wherein, when there is a request for information associated with the temporarily combined barcode from the payment device, the service device provides payment information about a user corresponding to the corresponding temporarily combined barcode as related information, to the payment device.

3. The service device according to claim 1, wherein the temporarily combined barcode of the random number includes payment information provided by the user when the terminal requests the combined barcode service, and is generated using a program for generating a random number.

4. The service device according to claim 1, wherein the payment additional information includes at least one of discount card information, point accumulation information for each card, and mileage accumulation information.

5. The service device according to claim 1, wherein the payment means information includes at least one of a credit card, a debit card, a gift card, and account transfer information.

6. A payment service method comprising:
requesting, by a terminal, a combined barcode from a service device so as to receive a payment service using a temporarily combined barcode of a random number from a user, when receiving an input of user information including a password and payment information from the user;
transmitting a combined barcode request signal to the service device when there is an input for a combined barcode request;
temporarily storing, when receiving the temporarily combined barcode from the service device, the received temporarily combined barcode;
determining whether a payment operation is performed using the temporarily combined barcode within a preset time; and
deleting the stored temporarily combined barcode when the payment operation is not performed based on the determination result.

7. The payment service method according to claim 6, wherein the payment information includes payment means information including at least one of a credit card, a debit card, a gift card, and account transfer information, and payment additional information including at least one of discount card information, point accumulation information for each card, and mileage accumulation information.

8. A payment service method comprising:
storing and managing, by a service device, a password and payment information received for each user, when receiving the password and payment information for a combined barcode request from a terminal;
generating a temporarily combined barcode of a random number using the payment information stored with respect to the user of the terminal requesting a combined barcode, when receiving a combined barcode request signal from the terminal; and
transmitting the generated temporarily combined barcode to the terminal.

9. The payment service method according to claim 8, wherein the payment information includes payment additional information including at least one of discount card information, point accumulation information for each card, and mileage accumulation information, and payment means information including at least one of a credit card, a debit card, a gift card, and account transfer information.

10. The payment service method according to claim 8, wherein the generating of the temporarily combined barcode of the random number includes the payment information provided by the user when the terminal requests the combined barcode service, and includes generating the temporarily combined barcode of the random number using a program for generating a random number.

11. A computer-readable recording medium for recording a program that the payment service method described in claim 6.

12. A computer-readable recording medium for recording a program that the payment service method described in claim 8.
